(19) United States
(12) Patent Application Publication
(10) Pub. No.: US 2010/0067173 A1
(43) Pub. Date: Mar. 18, 2010

(54) ENERGY STORAGE APPARATUS AND ARTICLE OF MANUFACTURE

(75) Inventors: Dominique Guillet, Orsonnens (CH); Laurent Gisler, Fribourg (CH)

Correspondence Address: Maxwell Technologies, Inc. (OPLF), 9244 Balboa Avenue, San Diego, CA, 92123, US

(73) Assignee: MAXWELL TECHNOLOGIES, INC., San Diego, CA (US)

(21) Appl. No.: 12/579,378

(22) Filed: Oct. 14, 2009

Related U.S. Application Data
(63) Continuation of application No. 11/558,424, filed on Nov. 9, 2006, now abandoned.
(60) Provisional application No. 60/734,806, filed on Nov. 9, 2005.

(51) Int. Cl. H01G 9/155; B65D 6/00

(52) U.S. Cl. 361/502; 220/677

(57) ABSTRACT

An energy storage apparatus and article of manufacture is disclosed. In one embodiment, the energy storage apparatus comprises a jelly roll, having a first and second sheet and a first and second separator member, and at least one terminal element. In another embodiment, an article of manufacture comprising forming a cylindrical housing and stamping a longitudinal indentation on an exterior surface of the cylindrical housing is disclosed. In one alternate embodiment, the longitudinal indentation is adapted to slowly fracture under pressure exerted on an interior surface of the cylindrical housing, thereby preventing catastrophic failure, such as for example an explosion.

### CROSS-REFERENCE TO RELATED APPLICATIONS

This patent application claims the benefit of and is a continuation of U.S. patent application Ser. No. 11/558,424, which was filed on Nov. 9, 2006, and which is incorporated by reference herein for all purposes, and also claims the benefit of U.S. provisional patent application 60/734,806, filed on Nov. 9, 2005, which is incorporated by reference herein for all purposes.

### FIELD OF INVENTION

The subject matter of this application relates generally to capacitors and capacitor housings and relates more particularly to double-layer capacitors and double-layer capacitor housings.

### BACKGROUND

Conventional capacitor technology is well known to those skilled in the art. The energy and power density that can be provided by conventional capacitor technology is typically low, for example, conventional capacitors are normally capable of providing less than 0.1 Wh/kg. Applications that require greater energy density from an energy source, therefore, typically do not rely on conventional capacitor technology. The amount of energy delivered by conventional capacitor technology can be increased, but only by increasing the number of capacitors.

Relatively recently in the energy storage field, a capacitor technology called double-layer capacitor technology, also referred to as ultra-capacitor technology and super-capacitor technology, has been developed. Double layer capacitors store electrostatic energy in a polarized electrode/electrolyte interface layer that is created by an electrical potential formed between two electrode films when a finished capacitor cell is immersed in an electrolyte. When the electrode forms and associated collecting plates are immersed in the electrolyte, a first layer of electrolyte dipole and a second layer of charged particles and a second layer of charging species is formed (hence the name “double-layer” capacitor). Individual double-layer capacitor cells are typically available with values greater than 0.1 Farad and above. For any given housing size, a double-layer capacitor cell may provide on the order of about 100-1000 times, or more, as much capacitance as a conventional capacitor cell. In one example, the energy density provided by a double-layer capacitor is on the order of about 10 Wh/kg, and the power density is on the order of about 10,000 W/kg.

### BRIEF DESCRIPTION OF THE DRAWINGS

FIG. 1 shows a cross-section of an embodiment of a double-layer capacitor structure.

FIG. 2 shows a top view of a jelly-roll double layer capacitor structure being wound.

FIG. 3 shows an embodiment of a battery form factor sized capacitor structure.

FIG. 4 shows a perspective view of an embodiment of a jelly-roll type double-layer capacitor cell.

FIG. 5A shows a cross-section of an embodiment of a double-layer capacitor structure.

FIG. 5B shows an embodiment of a cover for a double-layer capacitor structure.

FIG. 5C shows a stack of a plurality of covers shown in FIG. 5B for double-layer capacitors.

FIG. 5D shows an embodiment of a conductor used in a construction of a double-layer capacitor.

FIG. 5E shows an embodiment of a housing for a double-layer capacitor.

FIG. 5F shows an embodiment of a jelly-roll positioned within a housing.

FIG. 5G shows another embodiment of a housing for a double-layer capacitor.

FIG. 5H shows an embodiment of an electrode layer of a double-layer capacitor.

FIG. 5I shows an embodiment of a seal between a housing and a cover of a double-layer capacitor.

FIG. 5J shows a cross-section of an embodiment of a double-layer capacitor.

FIG. 5K shows a cross-section of an embodiment of a double-layer capacitor.

FIG. 5L shows a perspective view of an embodiment of a double-layer capacitor housing.

FIG. 5M shows a perspective view of an embodiment of a double-layer capacitor housing.

FIG. 5N shows a plan view of an embodiment of a plurality of interconnectable double-layer capacitor structures.

### DETAILED DESCRIPTION

In one embodiment, four 2600 F|2.5 V|60 mm×172 mm|525 g| sealed capacitors are interconnected as a series string of capacitors. In one embodiment, it has been identified that when charged to 10 volts, over 1500 amps of instantaneous peak current may flow through such four series connected capacitors at through their terminals. Accordingly, in one embodiment each capacitor preferably comprises terminals and interconnections that are sized to safely carry 1500 amps of peak current. Although only four series connected capacitors are discussed, the scope of the embodiments and inventions described herein envisions the interconnection of less or more than four series and/or parallel connected capacitors.

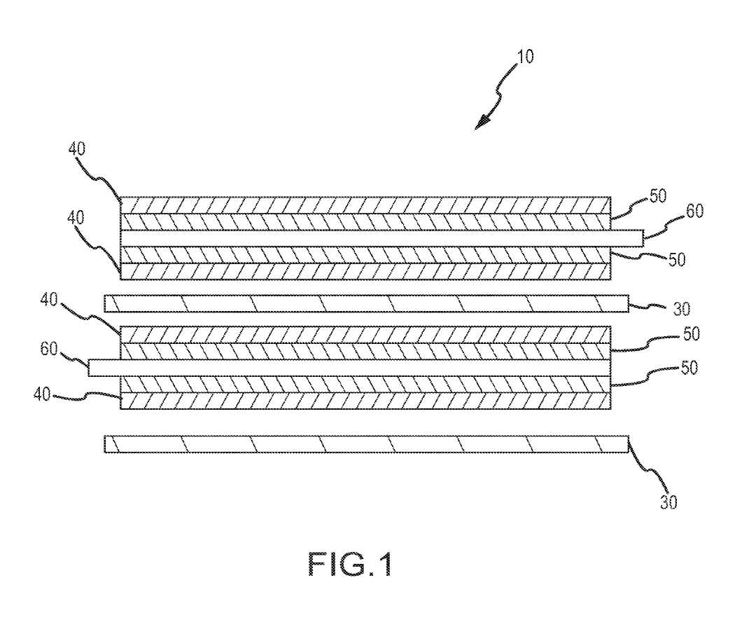

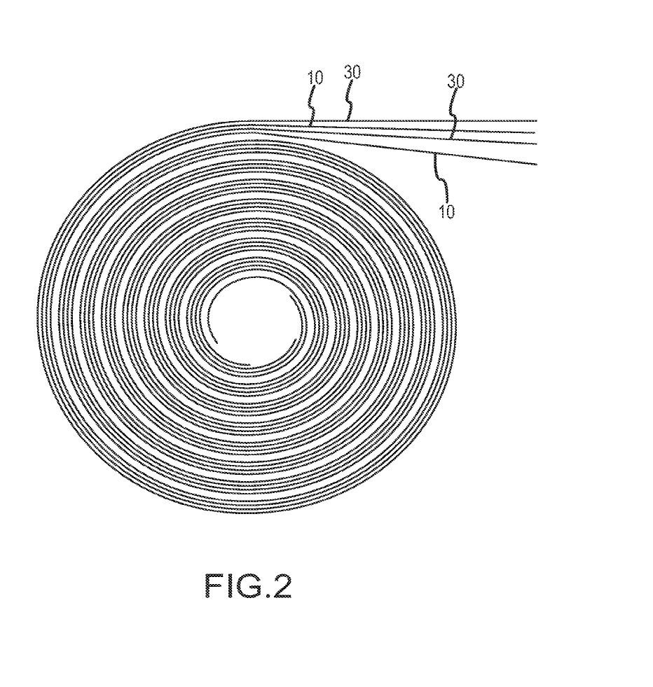

Referring now to FIG. 1 there are seen structures of a double-layer capacitor. In FIG. 1, double-layer capacitor sheet 10 like structures are shown in a cross-section. The sheets 10 can be visualized to extend inward and outward from FIG. 1. Each sheet 10 comprises two electrode films 40 and a current collector plate 60. First surface of the electrode films 40 are coupled to the collector plate 60. In one embodiment, the electrode films 40 are bonded to a collector plate 60 by a respective conductive adhesive layer 50. In one embodiment, the electrode films 40 are formed from a fibrillized blend of dry Teflon and dry activated and dry conductive carbon particles without use of any solvent, liquid, and the like (i.e. dry particle based) process steps. In one embodiment, the adhesive layers 50 are formed from a blend of dry conductive carbon particles and dry binder particles without use of any solvent liquid, and the liked (i.e., dry particle based) process steps. In other embodiments, the electrode films 40 and adhesive layers may be formed by other processes known to those skilled in the art, including by extrusion and/or coating. First and second sheets 10 are separated by a first separator 30. A second separator 30 is provided to comprise an outermost separator (relative to the center of jelly-roll that is subsequently formed), as is illustrated by FIG. 2. The two sheets 10 are rolled together in an offset manner that allows an exposed end of a collector plate 60 of the first sheet 10 to extend in one direction and an exposed end of a collector plate 60 of the second sheet 10 is extend in a second direction. The resulting capacitor geometry is known to those skilled in the art as a jelly-roll and is illustrated in a top view by FIG. 2. In one embodiment, the current collector plate 60 comprises an etched or roughened aluminum foil of about 30 microns in thickness. In one embodiment, the adhesive layers 50 comprise a thickness of about 5 to 15 microns. In one embodiment, the electrode films 40 comprise a thickness of about 80 to 250 microns. In one embodiment, the paper separator 70 comprise a thickness of about 20-40 microns.

Double-layer capacitors have intrinsic properties that limit their maximum charging voltage to a theoretical value of no more than about 4.0 volts. In one embodiment, a nominal maximum charging voltage of a double-layer capacitor is in a range of about 2.5 or 3.0 volts, which it is identified is a voltage that encompasses the output voltage of a wide range of available rechargeable and non-rechargeable batteries.

It is identified that double-layer capacitors can be designed to comprise a power density that is greater than lead acid, and many Nickel Cadmium, Lithium, and Alkaline type batteries; and with an energy density that approaches that of, or overlaps, the energy density available from lead acid, Nickel Cadmium, Lithium, and Alkaline batteries.

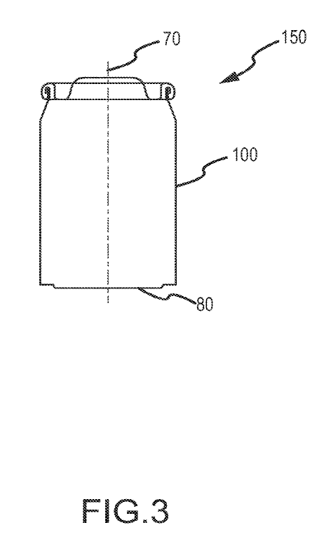

Referring now to FIG. 3, three is seen a battery form factor sized capacitor. In one embodiment, a double-layer capacitor is designed to conform to a battery form factor. Although an exemplary embodiment herein describes a battery form factor sized capacitor, the present invention will be understood to fine applicability with other form factors, whether standardized or not. Those skilled in the art will understand that standardized battery form factor sized housing may vary within tolerances that have been established and accepted by manufacturers and those skilled in the art. The dimensions of standardized battery form factor sized housing can be obtained from intentional standards body IEC located at Central Office, 3, rue de Varembé, P.O. Box 131, CH-1211 GENEVA 20, Switzerland. Primary cell from factor standards known to those skilled in the art that are within the scope of the present invention are referenced in International Standard IEC Standard 60086-1—Ed. 9.0, which documents primary batteries with respect to their electrochemical system, dimensions, nomenclature, terminal configurations, markings, test methods, typical performance safety and environmental aspects, and which is incorporated herein by references. Secondary cell form factor standards known to those skilled in the art that are within the scope of the present invention are referenced in International Standard IEC Standard 61951-1—Ed. 2.0, which documents secondary batteries with respect to their electrochemical systems, dimensions, nomenclature, terminal configurations, markings, test methods, typical performance safety and environmental aspects, and which is incorporated herein by reference. Standardized battery form factor housings and terminal dimensions and configurations can also be obtained from American National Standards Institute (ANSI) located at Washington D.C. Headquarters 1819 L Street, NW (between 18^{th} and 19^{th} Streets), 6^{th} floor Washington, D.C. 20036. ANSI standards for batteries are known by those skilled in the art as ANSI/NEDA standards. For example, an ANSI standard for D-cell sized battery housings is known as ANSI/NEDA 13A, an ANSI standard for C-cell size battery housings is known as ANSI/NEDA 14A, an ANSI standard for AA-cell sized battery housings is known as ANSI/NEDA 15A, an ANSI standard for D-cell sized battery housings is known as ANSI/NEDA 24A, and an ANSI standard for 9 volt sized battery housings is known as ANSI/NEDA 1604A.

In one embodiment, a battery form factor sized housing manufacture as an Energizer™ brand D-cell sized batter comprises a diameter of about 32.3-34.2 mm and height of 59.5-61.5 mm. Accordingly, in one embodiment, a battery form factor sized capacitor housing 100 comprises a diameter of about 33+0/−1 mm and a height of about 61.5+0/−2 mm, which are dimensions that are within the ANSI/NEDA and IEC dimensions for D-cell sized battery housings, and Energizer brand batter D-cell dimensions. It is understood that, D-cell dimensions are illustrative of one possible standardized battery form factor sized housing that is within the scope of the present invention, which should be limited only by the scope of the claims. For example, a C-cell form factor sized capacitor housing can comprises a diameter of about 25.2+0/−1 mm and a height of about 49.0+0/−2 mm, an AA-cell form factor sized capacitor housing can comprise a diameter of about 13.0+0/−1 mm and a height of about 50.0+0/−2 mm, and a AAA-cell form factor sized capacitor housing can comprise a diameter of about 10.0+0/−1 mm and a height of 44.0+0/−2 mm. In one embodiment, a double-layer capacitor in a D-cell form factor sized capacitor housing 100 has been demonstrated to provide 425 F, 3.2 mOhm at about 2.5 Vdc in a 56 g cell and an energy density of about 6.5 Wh/kg and a power density of about 8.7 kW/kg.

In one embodiment, a capacitor housing 100 may be provided with external electrode connections/connectors/terminals 70, 80 similar to, or the same as, those of standardized batteries. Inclusion of battery style terminal ends on a capacitor housing 100 enables that the housing can be provided to easily connect to apparatus that utilize battery style connectors of a reverse sex. Because existing standardized battery style connectors, and modules that use them, can be readily obtained from manufacturers, redesign time and costs can be appreciably reduced when implementing one or more of the embodiments described here.

Standardized battery style connections/connectors/terminals 70, 80 can also be used to connect multiple capacitor housings 100 together. For example, as with batteries, the operating voltage of a double-layer capacitor 150 may be increased by connecting two or more double-layer capacitors in series. The use of standardized battery style connections/connectors/terminals 70, 80 facilitates such series connections. As well, standardized battery style connections/connectors/terminals 70, 80 can be used to facilitate parallel connections. Battery style connections 70, 80 allow easy drip in capacitor replacement of batteries to be made. The benefits and advantages of the embodiments described herein enable easy connection and replacement of battery technology with double-layer capacitor technology, and thus, increase the number of potential applications that double-layer capacitors can be used in. Furthermore, a change of energy component type, from batter to double-layer capacitor, finds interest in applications where maintenance cost is a key factor, or where cyclability is important.

In one embodiment, it is identified that the ends 70, 80 of a battery form factor sized capacitor housing 100 lend themselves well to a geometrical design that exhibits a relatively large electrical conductive surface area, as compared to conventional capacitor housings that provide small diameter leads, terminals, etc. For example, in one embodiment, a D-cell battery form factor sized capacitor housing 100 may be designed to comprise conductive end surface area(s) of greater than 90 mm². The large electrical contact surface area at the ends of a D-cell form factor sized capacitor housing 100 allows that high current may flow through the end with minimal electrical loss. Because double-layer capacitors can supply or receive higher current than comparable batteries, the large surface area ends 70, 80 can be used advantageously for this purpose. Large surface area ends 70, 80 also allow that the ends may be provided in many geometrical variations and yet remain within the required dimensions of a particular battery form factor. For example, appropriate dimensioning of the ends 70, 80 may be made to provide large screw-in type connections, mechanical pressure type connections, welding/solder type connections, as well as others that in the capacitor prior art would not be practical or not possible.

Double-layer technology is now capable of being provided with energy and/or power density performance characteristics that approach or exceed those of batteries. Accordingly, it has been identified that double-layer capacitor technology can housed in a standardized battery form factor sized housing to supplement, or substitute for, equivalent sized batteries. Double-layer capacitor technology in a battery form factor sized housing 100 may also improve upon battery technology. For example, a D-cell sized double-layer capacitor 150 can provide many more charge/recharge cycles than may achieved by a D-cell sized rechargeable battery. Because double-layer capacitors utilize an electrostatic storage mechanism, they can be cycled through hundreds of thousands of charges and discharges without performance degradation, which compares with life cycles of less than 1000 for rechargeable batteries.

Although discussed with reference to a D-cell form factor sized housing 100, the present invention is not limited to a D-cell form factor housing and/or standardized battery electrode connections/connectors/terminals 70, 80. For example, one or more of the above identified principles and advantages can be used to effectuate other battery form factor sized capacitor housings and connectors. For example, it is identified that many power tools are now powered by batteries in a power tool specific form factor housing. In one embodiment, double-layer capacitor(s) may be housed is such a manufacturer specific housing. Although some double-layer capacitors may not have the energy density of batteries, the do typically have more power density than batteries, and thus, can be used as a short-term substitute for a power tool battery pack. Because a double-layer capacitor based energy source in a battery form factor sized capacitor housing can be recharged more quickly than a battery, for example, on the order of 15 seconds or so, as opposed to the tens of minutes for a battery, double-layer capacitor technology can be utilized as a battery substitute or supplement when re/charge times are critical.

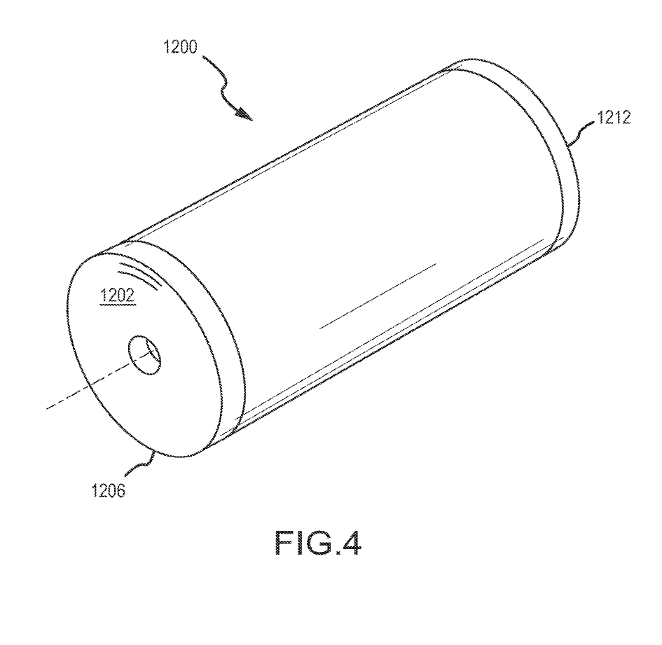

Referring now to FIG. 4, there is seen a perspective view of a jelly-roll type double-layer capacitor cell. In one embodiment, ends of one offset collector extend from one end 1212 of a rolled double-layer capacitor 1200, and ends of another offset collector extend (represented by exemplary collector extensions 1202) from another end 1206. In one embodiment, the capacitor is rolled about a centrally disposed rod, which after rolling may be removed to thus leave a centrally disposed void within the jelly-roll.

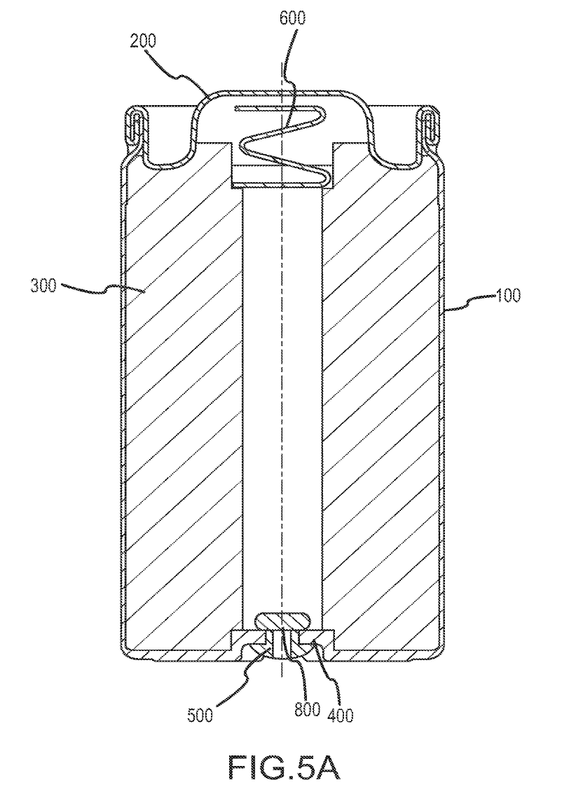

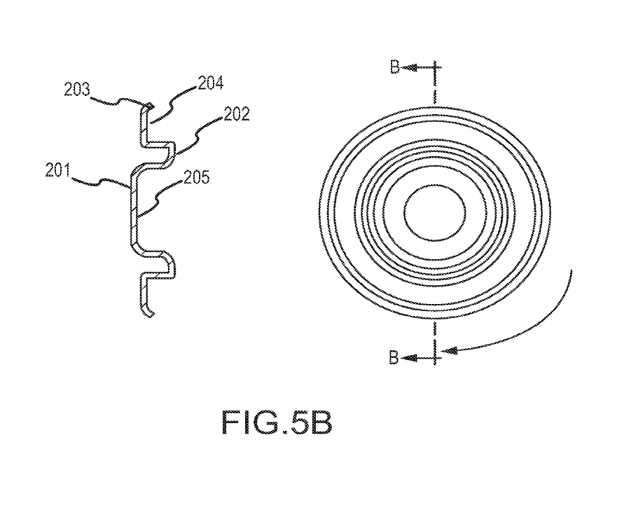

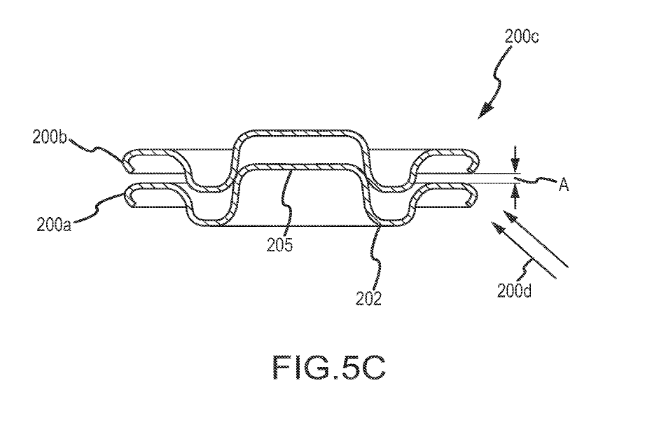

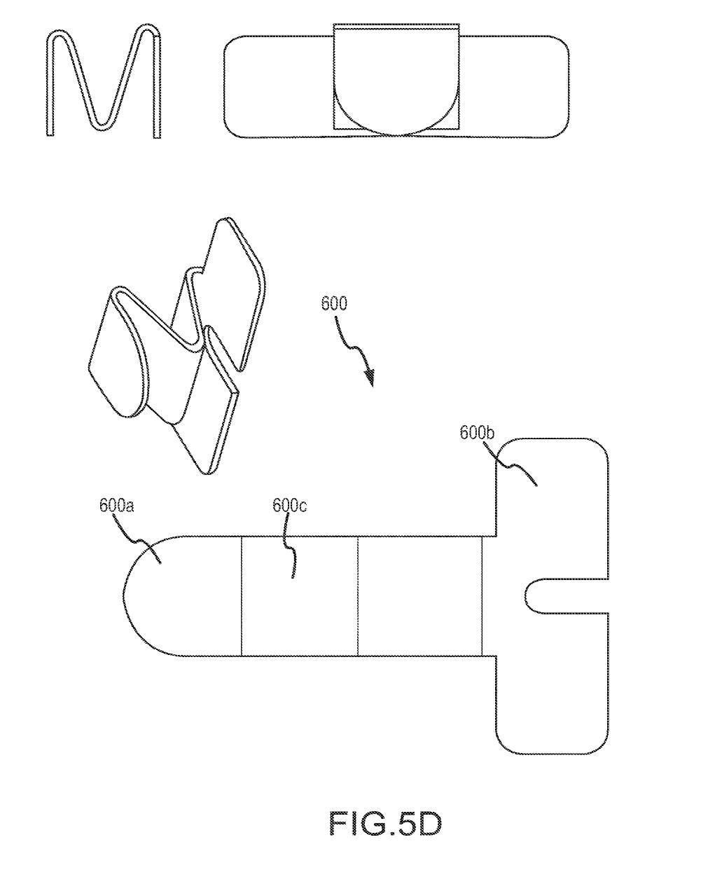

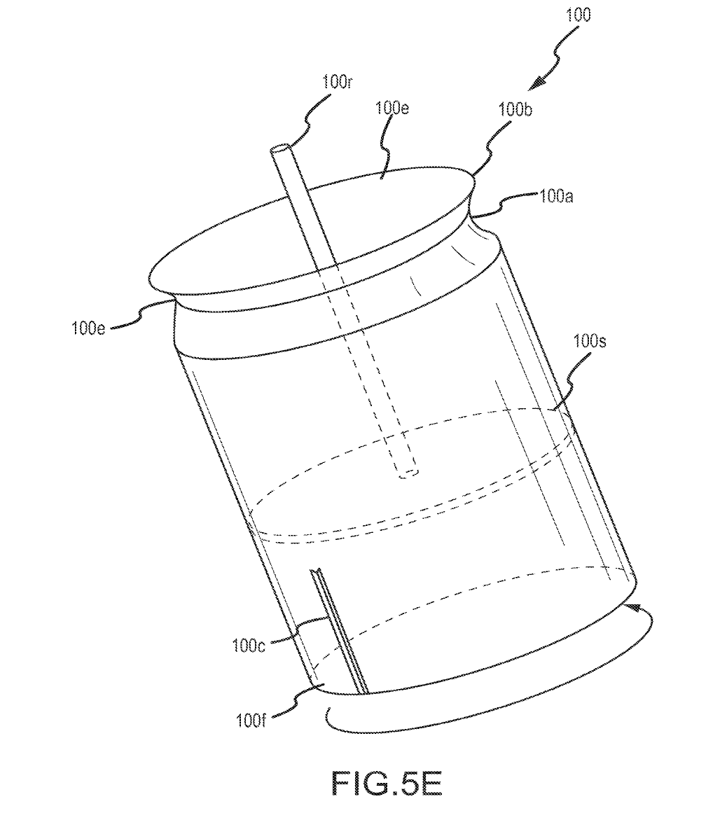

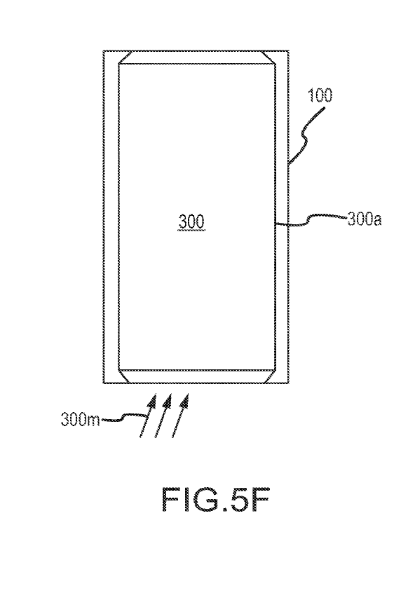

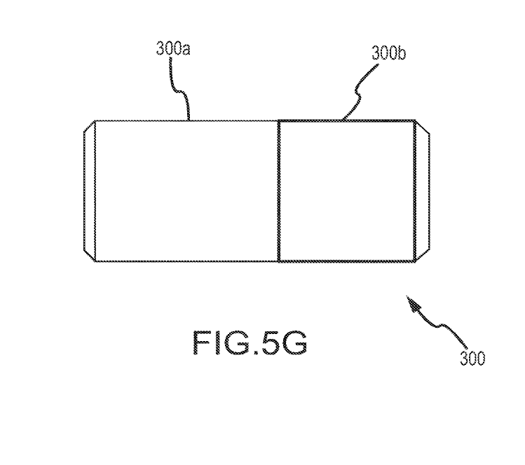

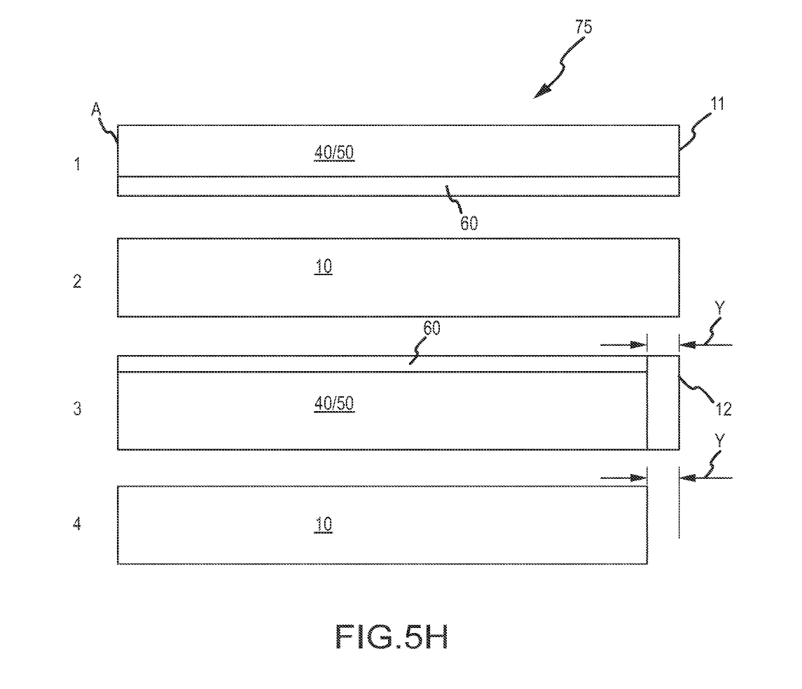

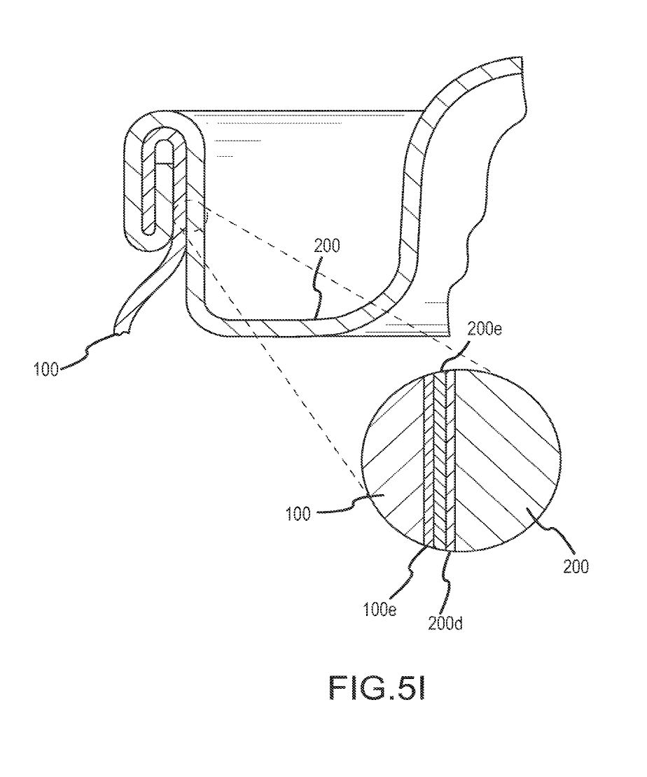

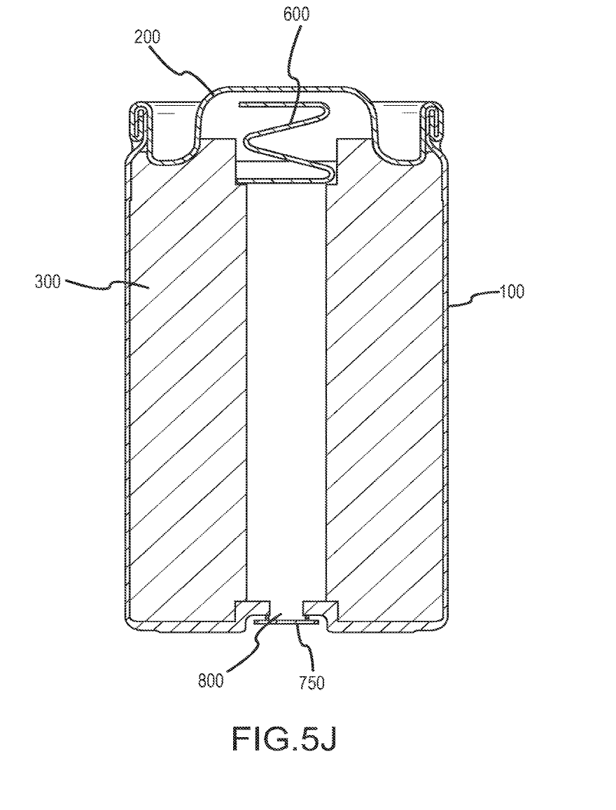

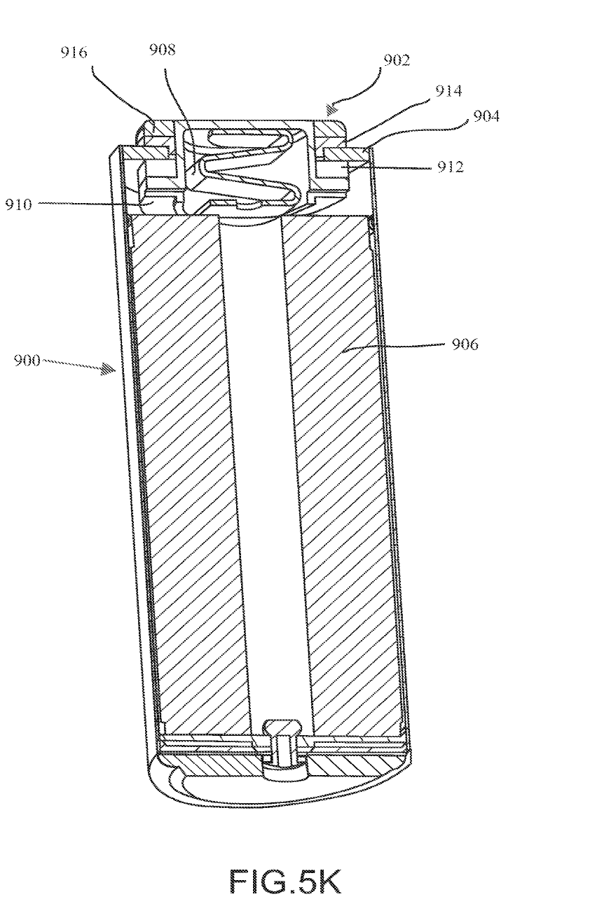

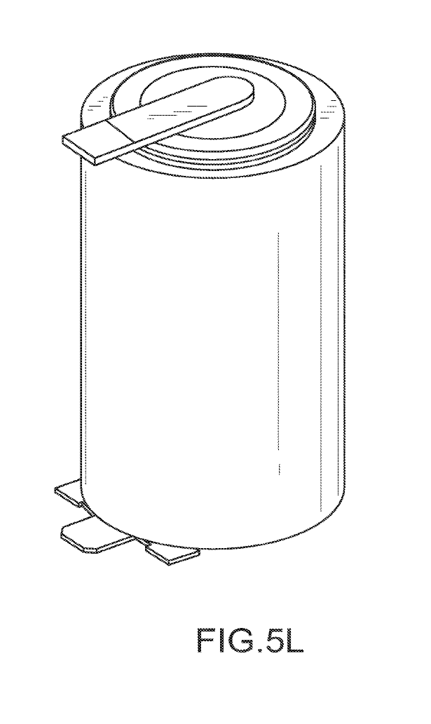

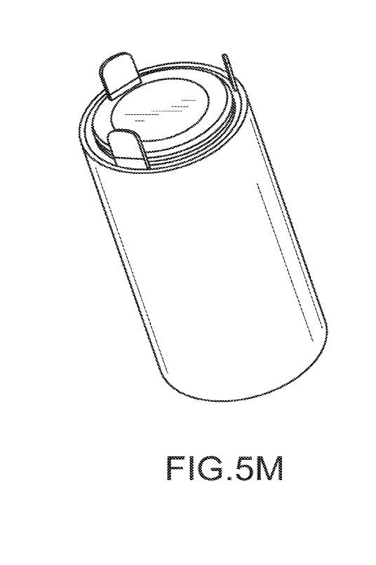

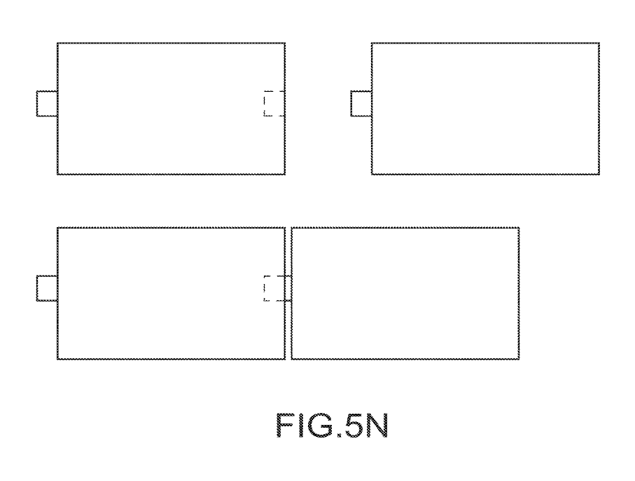

Referring to FIG. 5a, and preceding Figures as needed, in one embodiment a D-cell form factor double-layer capacitor comprises a housing 100, a cover 200, and a jelly-roll electrode 300. In one embodiment, the housing comprises aluminum, and the cover 200 comprises aluminum.

With reference to FIG. 5b, and preceding Figures as needed, in one embodiment the cover 200 may be extruded, shaped, machined, molded, and/or stamped to conform or comprise the general shape of one end of a D-cell battery. As seen in FIG. 5b, in its unassembled form, the cover 200 comprises a circular geometry with an upper 201 and lower 202 surface and curved outer periphery 203. The lower surface 202 at the outer periphery is later coupled to the housing 100 during a process that forms a seal between the cover 200 and the housing 100.

An assembled double-layer capacitor comprises a positive and negative polarity. To electrically separate such polarity, an electrical insulator or insulation may be provided, for example, as between a cover 200 and a housing 100. In one embodiment, a sealant may also be provided between the cover 200 and the housing 100.

In one embodiment, it is identified that electrical connection needs to be made between the cover 200 and the jellyroll 300, and for this reason, a portion of the surface 202 to which insulator has been applied is preferably left bare of insulator. In one embodiment, a central portion 205 of the surface 202 is left bare.

It is identified that when a material is required to be applied to only a portion of a cover 200, the bare portion of the cover is typically masked from the material. Such masking, as well as application of material, is time consuming in that it requires individual handling of each cover as well as other processes.

Referring to FIG. 5d, and preceding Figures as needed, in a subsequent step, a semi rigid electrically conductive metal 600 is connected to a bare central portion 205 of the bottom surface 202 of a cover 200. Initially the metal 600 is formed of a 0.6 mm thick flat sheet of aluminum. The metal 600 is of sufficient cross-sectional area to be able to pass 1500 amps of current without damage to the metal 600 or the connections made to couple the metal to the cover and jelly-roll. The metal is formed into a geometry that comprises a first end 600a, a second end 600b, and a middle portion 600c. In one embodiment, at the second 600b, the metal comprises a portion that extends generally perpendicular to an axis formed through the first portion 600 and the middle portion 600c. In one embodiment, the second end 600b, comprises a centrally disposed void 600d. The void may comprise a slot, a hole, or other opening. Before attachment to a cover 200, the metal 600 may be bent at the middle portion 600c twice such that when viewed in a cross-section the metal comprises a shape similar to that of an “M”. In this “M” configuration, the first end 600a is attached to a central portion 205 of a cover 200. Attachment is preferably made be welding, for example, by a spot weld or a laser weld. After attachment of a metal 600 to a cover 200, the cover is placed aside until needed, as will be described further below.

Referring to FIG. 5e, and preceding Figures as needed, in a subsequent step, a housing 100 is obtained. In one embodiment the housing 100 is formed to comprise at its open end an inwardly curved neck portion 100a and an outwardly directed lip portion 100b. This geometry effectuates sealing between a cover 200 and the housing 100 during a subsequent curling/sealing step. Other geometries are also within the scope of the invention. In one embodiment, forming (for example, necking, sealing) etc. may be effectuated after insertion of a jellyroll 300 within the housing, with implementation of such processes known to those skilled in the art. In one embodiment, the housing 100 may be subject to application of a stamping or other forming force during manufacture of the housing, which forms a longitudinal indentation 100c into the housing. It is identified that the indentation 100c may be used to weaken the housing to an extent that allows the indentation to slowly crack or open under a specific pressure. The ability to slowly crack or open protects a sealed capacitor product from exploding catastrophically during some of its failure modes. In other words, the indentation 100c can provide functionality similar to that of a “fuse,” wherein at a certain pressure, the indentation safely renders the capacitor to be non functional.

The exterior and interior of the housing 100 are cleaned using techniques known to those skilled in the art.

In one embodiment, an electrical insulator 100e is applied to the exterior and the interior of the housing 100. In one embodiment, the insulator 100e is applied to the housing while the can is subject to spinning about a central longitudinal axis. In one embodiment, the insulator 100e is applied by spraying the insulator. In one embodiment, the insulator 100e is applied to only a portion of the exterior and the interior of the housing 100. For example, it is identified that the interior and exterior of the housing 100 may need be coated to an extent needed to effectuate subsequent sealing of the housing 100 by a cover 200.

Referring to FIG. 5f, and preceding Figures as needed, in one embodiment, a jelly-roll 300 comprising offset collectors is positioned within an open end of a housing 100. It is identified in an embodiment wherein the housing 100 is provided with one polarity and the cover is provided with the opposite polarity, an orientation of the jelly-roll 300 within the housing 100 can affect performance of a final capacitor product. For example, when an extending collector associated with the outermost electrode layer 300a is coupled to the positive polarity of the cover 200 (i.e. “flipped” jelly-roll orientation), the positive polarity of the cover can become electrically shorted by the outermost electrode layer to the negative polarity of the housing. Although, in one embodiment jelly-roll 300 may be physically separated from the housing 100 by an outermost paper separator 30 (FIG. 1d), because paper separator 30 is porous, it does not act to fully electrically separate the jelly-roll from the housing when subsequently impregnated with conductive electrolyte. As well, use of paper separator 30 may act to thermally isolate the jelly-roll 300 from the housing 100, which may act to limit thermal dissipation of heat generated by the jelly-roll 300 by the housing, which may as a consequence reduce the lifetime of the jelly-roll.

Referring to FIG. 5g, and preceding Figures as needed, in a “flipped” jelly-roll orientation, to provide electrical insulation from a housing 100, an additional outermost sleeve of thin plastic or other insulative material 300b may be applied to a jelly-roll 300.

Referring again to FIG. 5e, in one embodiment, an electrical insulator is applied from a top portion of the walls of interior of the housing 100 to a bottom portion. In one embodiment, the electrical insulator is applied as a fixed spray during a time the housing is rotated. Such coating can be applied as a natural extension of coating the upper outer and upper inner portions of the housing 100. As a result, in an embodiment wherein a jelly-roll is inserted in a flipped orientation, as well as in a flipped orientation, when an insulator 100e is applied to the interior walls of the housing, an insulating material 300b may not need to be used.

In one embodiment, after a step of insertion of a jellyroll 300 within the housing 100, the collectors at one end of the jelly-roll are electrically coupled to the housing by welding. During welding, it is desirable to press down onto the jelly-roll 300 so as to have a more extensive contact and interface between the collectors and the housing 100. In a preferred embodiment, welding is effectuated in a laser welding step, wherein a beam of laser light 300m (FIG. 5f) is applied in a particular pattern to the exterior bottom end of the housing 100. Preferably, the beam of laser light is of sufficient intensity to heat the housing 100 and the collectors of the jelly-roll 300 so as to physically and electrically bond the collectors to the housing 100 without damaging the housing or the jelly-roll.

It has been identified that any impurities, dirt, residue, and/or over spray present at the inner bottom end 100f can act to interfere with the welding process. For example, it is identified that overspray from the application of the insulator 100e to the interior walls of the housing 100 can occur and be deposited on inner bottom end 100f of the housing. Such overspray can interact with the externally applied laser beam by acting to locally increase the temperature at the point of application of the laser light 300m. Such increased temperature can act to burn through the bottom end of the housing 100 and/or damage the housing and/or jellyroll 300.

Additionally, such increased temperature can act to interact with the insulator 100e to release or create impurities that can subsequently affect operation of the jelly-roll 300.

After insulator 100e is applied to the interior of the housing 100, the insulator may be dried under appropriate temperature, and a jelly-roll 100 is inserted within the housing (FIG. 5f). Prior to insertion within the housing 100, the extending collectors of the jelly-roll 300 at both ends may be bent over such that coextensive surface contact between the collectors can be achieved and such that better electrical and welded contact can subsequently be made thereto.

In one embodiment, wherein an extending collector associated with an outermost electrode layer 300a is coupled to the housing 100 (an “unflipped” jelly-roll orientation), and wherein direct electrical contact between an outermost electrode layer and the housing 100 may be desired to reduce electrical resistance between the housing and the outermost collector of the outermost electrode layer, it is understood that the above described insulator 100e would need to be applied only to the upper inner portion of the housing 100 that is used for subsequent sealing.

To this end, it is identified that in an “unflipped” jelly-roll 300 orientation, it may be preferred during or after manufacture of capacitor sheets 10 (FIG. 5H) to remove a portion of the electrode film 40 and, if used, adhesive layer 50, from the sheet 10 corresponding to the outermost electrode layer 300a.

In one embodiment, prior to insertion within the housing 100, the end of the jelly-roll 300 that would extend from the open end of the housing is attached to the bottom end 600b of the conductive metal 600 (FIG. 5d). In one embodiment, the bottom 600b is attached to the jelly-roll 300 by application of laser beam during a time the bottom is maintained in centralized contact with the end of the jelly-roll. The laser beam is preferably of a magnitude that during welding of the bottom end 600b to the jelly-roll 300, the jelly-roll does not become damaged, but of sufficient magnitude that solid connection is made to the collectors of the jelly-roll.

Referring to FIG. 5J, in one embodiment, the jelly-roll 300, is sealed within the housing 100 by placing the cover 200 onto the housing, and by application of a force to the cover 200 and the upper portions 100a-b of the housing (FIG. 5e) to mechanically curl the cover and upper portion at the same time and in a manner that the sealant 200e previously applied to the cover creates a hermetic seal against release and influx of gases, liquids, impurities, etc. and, as well, such that the insulator 100e and 200d previously applied to the housing and cover acts to electrically insulate the cover from the housing.

It is identified that during the step of applying the cover 200 to the housing 100, the metal 600 (FIG. 5a) will become further folded at the previously bent portions, and that when the cover is fully sealed against the housing, a spring action of the bent metal may act to apply a downward force onto the jelly-roll 300. This spring action may help to make better contact between the jelly-roll 300 and the housing 100 in an embodiment wherein the bottom end of the jelly-roll is laser welded to the bottom end of the housing after the housing is sealed by a cover 200.

In one embodiment, after a housing 100 is sealed by a cover 200, the resulting capacitor product may be impregnated with electrolyte by introduction of the electrolyte through a sealable fill port 800.

Referring to FIG. 5i, and preceding Figures as needed, in one embodiment, a fill 800 is sealed by a separately applied metal, for example, aluminum. In one embodiment, the applied metal is in the form of a disk 750. After introduction of electrolyte via fill hole 800 within a housing 100 that has been sealed by a cover 200, an appropriately dimensioned disk 700 is placed over the fill hole, and an ultrasonic welding process is used to attach the disk to the housing and to seal the fill port at the direct to metal contact exposed to the ultrasonic weld.

In one embodiment, it is identified that by appropriate selection of a thickness of the separately applied metal, the disk 750 itself can act as a “fuse,” which could be used in place or in combination with longitudinal indentation 100c (FIG. 5e), in which case at some pressure, the disk 750 may be used to release electrolyte within a sealed capacitor to render the capacitor safe and non-functional.

It is identified that the void within the jelly-roll 300 can be used facilitate the flow and impregnation of electrolyte within a sealed capacitor. Because many of the collectors of the jelly-roll 300 have during an insertion step been folded over inward toward the center of the jelly-roll, thus potentially blocking flow of electrolyte from one portion of the jelly-roll to another portion, the void in the jelly-roll can be used to assist in circulating flow of the electrolyte. However, it has been identified when the metal 600 spring is attached to the jelly-roll 300, the bottom end 600b of the metal spring may block the flow of electrolyte through the void within the jelly-roll. It is identified that when a corresponding void 600d or hole (FIG. 5d) is provided in the metal 600 spring, when such void 600d is aligned to the void in the jelly-roll 300, it may subsequently facilitate flow of electrolyte within the sealed capacitor product.

In one embodiment, it has been identified that external permanent electrical contact may sometimes be desired to be made to a battery form factor sized capacitor product. As has been described throughout, in one embodiment, a cover 200 and a housing 100 comprise aluminum. In one embodiment, it has been identified that aluminum oxidizes easily and as a consequence aluminum is a difficult metal to make electrical connections to. Without a provision for permanent electrical contacts, it is identified that contact resistance to ends of a double-layer capacitor product made of aluminum would be high, and at the high currents that double-layer capacitors may be used, excessive heat would be generated. Permanent electrical contacts to a capacitor product can be made by welding, but such welding entails high cost, both in money and time. In one embodiment, therefore, a housing 100 and/or cover 200 may be provided with a thin cladding of metal. In one embodiment, the metal is an Nickel based cladding that can be provided by BI-Lame. By providing a cover an external layer of such, cladding, it has been identified that subsequent electrical contact to the cover can be easily made, for example, by low heat soldering.

The above-described embodiment have been described. In doing so, a number of benefits as well as disadvantages may have been noted by the reader. For example, the use of laser welding may cause damage to a capacitor cell, housing, or other component. The use of sealants and insulators requires process steps that may be costly in both time and money. Sealing of a cover to a housing by curling may impact time and money, and as well affect reliability. Hence the present inventors suggest in the following summary various changes, that alone, or in combination with features described herein can make a capacitor product more reliable, cheaper, and more easy to manufacture.

Referring to FIG. 5k, in one embodiment, a capacitor comprises a housing 900 and a cover 902. In this embodiment no insulator and sealants are necessarily required. As well no necking and flanging is necessary required. Such effect is achieved because a seal between the cover 900 and housing 902 can be achieved without the use of insulators and sealants discussed previously above. In one embodiment, the cover comprises a first disk 904, which may fittably inserted within an opening in a housing. Subsequent joining of the disk to the housing may be performed by use of a conductive epoxy of the like, or by a welding process, for example, laser welding. Prior to joining of the disk to the housing, a jelly roll may be prepared in a manner similar to that discussed above. At one end of the jellyroll 906 a bendable metal 908 may be attached by welding to the jelly roll 906, the metal being subsequently attached and/or welded to the cover 902 or a portion thereof. Subsequently, prior to the insertion within a housing, bendable metal foils or bendable metal tabs that are attached at an end of the jellyroll may be bent over to overlap a central portion of the jellyroll such that after the end of the jellyroll is inserted within the housing to abut against an inner bottom end of the housing, a welding tip may be inserted within the central void formed within the jellyroll to abut against the bent foils and/or tables. The bend foils and/or tabs can subsequently be welded to the interior end of the housing. Such welding through the void in the jellyroll eliminates a blind weld that was described in the previously described laser weld process to occur from outside of the housing. By eliminating the blind weld, defective welds are more easily able to be identified. As well, as a consequence, because jointment between the jellyroll collectors foils can be more reliably made at to bottom end of the housing, the ESR of the capacitor may be improved. When welding through the central void of a jellyroll, it is identified that the previously described fill hole may need to be positioned at some other location.

In one embodiment, the cover is comprised of a number of components, that when assembled, provide a seal against leakage of subsequently introduced electrolyte. As described above, a cover comprises a first disk 904 (washer negative). In one embodiment, the first disk has a centrally disposed void within which a slightly smaller metal piece comprising a protrusion can be placed (lid positive 910). At one end of the metal piece, the bendable metal 908 used to connect to the upper end of the jelly roll collectors can subsequently be attached to frame a spring. The first disk and metal piece are dimensioned such that when a sealing separator (seal EPDM 912) is placed over the protrusion, and when the protrusion is inserted within the void of the first disk, the protrusion extends through the void in a manner that a seal may be formed therebetween. At a side of the first disk through which the protrusion extends, over the protrusion is placed a insulating separator (insulation washer 914) that electrically insulates and separates the protrusion, and hence the metal piece form the first disk, and as well a subsequently place retaining right (retaining washer 916). The retaining ring is as well shaped as a second disk with a centrally disposed void that has dimension that allow the void of the second disk to forcibly snapped over the protrusion such that the rubber separator and the plastic separator can be maintained in sealable contact with the first disk. The resulting cover structure comprises a central portion (metal piece with protrusion snapably coupled to second disk) that is sealably and electrically isolated from the first disk. Subsequent bipolar electrical contact to a jellyroll capacitor cell can be thus made separately through the second disk, and separately to the retaining ring or the housing that the first disk is electrically coupled to (FIG. 5L)

It is identified that because the capacitor housing need not, thus, be necked or flanged radial electrical attachment to the capacitor can more easily be facilitated. In one embodiment an electrical connect or tab can be electrically attached or be part of one end of the housing, and another electrical tab can be attached or be made part of the second disk. Such tabs can extend in the same direction to facilitate attachment to RCBs in a vertical configuration (FIG. 5M).

It has been identified by the inventors that electrical interconnections between capacitors connected in series or parallel can be made using thermally fitted bus bars or interconnects where voids of an interconnect can be thermally expanded to fit over corresponding terminals. With similar materials (for example, aluminum) used for the terminals and interconnects, subsequent cooling of the interconnects causes the voids to contract about corresponding terminals to form a good mechanical/electrical connection. Capacitors or other devices can in this manner interconnected (mechanically and/or electrically) without the use of additional materials, such as screws, clamps, solder, welds, etc.

In one embodiment, it has been identified that housing and/or covers may be themselves be used to provide similar interconnect functionality. For example, in one embodiment, a cover of one capacitor is shaped with protrusion, and a housing of another capacitor is shaped with recess that can accommodate the protrusion. In one embodiment, the recess is dimensioned to have the same or slightly smaller dimension than the protrusion (FIG. 5N). For example, in one embodiment, the protrusion comprises a cylindrical shape, and the recess defines a cylindrical shape, wherein heat applied to the housing may be used to expand the diameter of the recess, which may then be placed over the terminal. Subsequent equilibration of the temperature for the recess and the terminal allows that a reliable mechanical and electrical interconnection can be made without the use of a bus bar. Such interconnection can be maintained over a wide range of temperatures to connect devices such as capacitors together.

In one embodiment, wherein initially a cover and/or a housing does not comprise an adequately dimensioned protrusion or void, the cover and/or housing may be modified. For example, a protrusion may be coupled to a cover or a housing, and/or a component with a recess can be coupled to the housing or the cover. In one embodiment, the coupled protrusion and the component with a recess may respectfully comprise a disk and a washer like element, wherein the disk fits within a void within the washer. In one embodiment, the protrusion and element with a void may be coupled to a respective cover and housing by means of welding, conductive glues, and others known to those skilled in the art.

Although the particular embodiment described herein are fully capable of attaining the above described advantages and objects of the present invention, it is understood that the description and drawings presented herein represent some, but not all, embodiments of the invention and are therefore broadly representative of the subject matter which is contemplated by the present invention. For example, a double-layer capacitor and/or housing may be designed to confirm to a standardized C-cell battery form factor, an AA-cell battery form factor, or an AAA-cell battery form factor. The above identified principles and advantages may be applied to standardized housing of other battery technologies, for example, NiMh, lithium, alkaline, Nicad, sealed lead-acid, and the like. The above identified principles and advantages may also be applied to other batteries and form factors that may exit or be developed and accepted in the future as standardized. As well, the insulation and sealants described herein may vary or be different in other embodiment. It is therefore understood that the scope of the present invention fully encompasses other embodiments that may become obvious to those skilled in the art and that the scope of the present invention should accordingly not be limited.

What is claimed is:

1. An energy storage device, comprising:
(a) a jelly roll, comprising:
(i) a first sheet, having a top side and a bottom side, comprising:
(A) at least two electrode films, operatively coupled to a first current collector plate, wherein a first electrode film is disposed along the top side of the first sheet, wherein the second electrode film is disposed along the bottom side of the first sheet;
(ii) a second sheet, having a first side and a second side, comprising:
(A) at least two electrode films, operatively coupled to a second current collector plate, wherein a first electrode film is disposed along the first side of the second sheet, wherein a second electrode film is disposed along the second side of the second sheet.
(iii) a first separator member, having an upper side and a lower side, wherein the separator member upper side is operatively coupled to the first sheet second electrode film, which is disposed along the bottom side of the first sheet, wherein the separator member lower side is operatively coupled to the second sheet second electrode film, which is disposed along the second side of the second sheet;
(iv) a second separator member, having an inner side and an outer side, wherein the inner side of the second separator member is disposed along and operatively coupled to the first sheet first electrode film, which is disposed along the top side of the first sheet, and;
(b) at least one terminal element, having a proximate end and a distal end, wherein the proximate end is in electrical contact with the jelly roll and the-distal end protrudes therefrom the jelly roll.

2. The energy storage device of claim 1, wherein the jelly roll is adapted store at least 250 Farads.

3. The energy storage device of claim 2, further comprising a battery form factor housing.

4. The energy storage device of claim 3, wherein the housing comprises the aluminum.

5. The energy storage device of claim 4, wherein the battery form factor housing comprises:
(a) a diameter of approximately 33±1 millimeter, and;
(b) a height of approximately 61.5±2 millimeters.

6. The energy storage device of claim 4, wherein the battery form factor housing comprises:
(a) a diameter of approximately 25.2±1 millimeter, and;
(b) a height of approximately 59.5 to 1.5 millimeters.

7. An article of manufacture, comprising:
(a) forming a cylindrical housing having an exterior surface and an interior surface, and;
(b) stamping a longitudinal indention oriented along a longitudinal axis, wherein the longitudinal indentation is stamped on the exterior surface of the cylindrical housing.

8. The article of manufacture of claim 7, wherein the longitudinal indentation is adapted to weaken the cylindrical housing under an exerted pressure, wherein the longitudinal indentation is further adapted to slowly fracture under a pressure exerted therein the cylindrical housing interior surface.

9. The article of manufacture of claim 8, wherein the cylindrical housing is further adapted to prevent a catastrophic explosion of the exterior surface of the cylindrical housing, whereby the longitudinal indentation is adapted to safely render the article of manufacture non-functional via slow fracture of the longitudinal indentation.

10. A means for storing electrical energy within a housing means, comprising:
(a) a jelly roll means, disposed inside the housing means, for storing electrical energy, and;
(b) a terminal means, responsive to the jelly roll means, for transferring electrical energy between the jelly roll means and an external contact.
